(19) United States
(12) Patent Application Publication
(10) Pub. No.: US 2003/0111419 A1
(43) Pub. Date: Jun. 19, 2003

(54) Purifying aqueous hydrogen peroxide solutions on ion-exchanging resins

(76) Inventors: Christine Devos, Versailles (FR); Sandrine Dufrenne Moutin, Lauragais (FR)

Correspondence Address: BURNS DOANE SWECKER & MATHIS L L P, POST OFFICE BOX 1404, ALEXANDRIA, VA, 22313-1404, US

(21) Appl. No.: 10/169,585

(22) PCT Filed: Jan. 3, 2001
(86) PCT No.: PCT/FR01/00018

(30) Foreign Application Priority Data
Jan. 7, 2000 (FR) 00/00187

(51) Int. Cl. C01B 15/01; B01D 15/00

(52) U.S. Cl. 210/660; 423/584

(57) ABSTRACT

The invention relates to a method of purifying an aqueous hydrogen peroxide solution by passing the solution over a cationic resin. The invention consists in passing it over the cationic resin under conditions in which the hydrogen peroxide solution is maintained at a temperature of between its freezing point and +10° C., advantageously between 0° C. and +5° C., so as to limit contamination of the solution by sulphate ions.

The present invention relates to an improvement to the purification of aqueous hydrogen peroxide solutions over ion-exchange resins. It relates more particularly to an improvement to the purification of the said solutions over cationic resins.

Aqueous hydrogen peroxide solutions, for use in the food, hygiene and health fields and most particularly the high-tech fields, such as microelectronics, must be increasingly pure in order to meet market specifications.

At the present time, the specifications for the purest products on the market are the following:

a concentration of each cation, such as Na⁺, Ca²⁺, Fe³⁺ and Al³⁺ of less than 10 ppt,

a concentration of each anion, such as Cl⁻, SO₄²⁻ and PO₄³⁻, of less than 30 ppb.

In recent years, the tendency has always been to lower the thresholds of these cation concentrations, and also these anion concentrations.

Several techniques have been described for the purification of aqueous hydrogen peroxide solutions. Among these, the most commonly used are distillation in glass columns and passage over ion-exchange resins.

The latter technique is particularly preferred when it is a question of achieving very low impurity levels. It may be carried out using various methods. In general, the solutions to be treated are brought into contact with:

at least one cation-exchange resin (called a cationic resin), which is highly acid and obtained by styrene polymerization and crosslinking by divinylbenzene followed by a treatment in sulphuric acid. The ionic sites linked to the polymer are thus sulphonate groups SO₃⁻ and the counterion, capable of being exchanged by a known impurity in the H₂O₂ solutions is the H⁺ ion;

at least one anion-exchange resin (called an anionic resin), which is highly basic and obtained by reacting a tertiary amine (for example, trimethylamine) with a chloromethylstyrene/divinylbenzene copolymer. The ionic sites linked to the polymer are thus quaternary ammonium groups N(CH₃)₃⁺. The hydroxyl counterion OH⁻ (capable of being exchanged by an anionic impurity contained in the H₂O₂ solutions) is to be proscribed since hydrogen peroxide decomposes very rapidly when it comes into contact with it. Carbonate CO₃⁼ and bicarbonate HCO₃⁻ forms, of lower basicity, are generally used. The use of such forms is especially described in patents U.S. Pat. No. 3,294,488, U.S. Pat. No. 3,305,314 and U.S. Pat. No. 3,297,404.

In contact with basic, or even highly basic, anionic resins, hydrogen peroxide decomposes. For obvious safety reasons, attempts are made to minimize this decomposition. Thus it is recommended, according to the prior art, to carry out the purification over anionic resins at a moderate temperature. In particular, Patent Applications FR-A-2,677,010 and FR-A-2,677,011 describe a process for purifying aqueous hydrogen peroxide solutions, in which the treated solutions are passed beforehand through a cationic resin medium, then cooled to a temperature of between their freezing point and 0° C. and finally passed through an anionic resin medium, which is itself cooled.

Moreover, it is known that anionic resins contain cations, especially sodium and calcium cations, these cations having a tendency to salt out in hydrogen peroxide solutions brought into contact with them. This phenomenon is particularly pronounced when the anionic resin has been put into carbonate or bicarbonate form by treatment with a concentrated aqueous solution of a carbonate or bicarbonate salt. Consequently, when at least one anionic resin and at least one cationic resin are involved on a site, the said anionic resin(s) is (are) placed before the said cationic resin(s), the latter resin(s) retaining, on the one hand, the cations initially present in the treated solution and, on the other hand, those provided by the said anionic resin(s).

In such a context, in which the problems of hydrogen peroxide decomposition over anionic resins and of salting-out of cations by the said anionic resins were already known and in which solutions to these problems have already been employed, the inventors have demonstrated a new technical problem, namely the fact that cationic resins bring sulphate ions into the aqueous hydrogen peroxide solutions brought into contact with them. Thus, an aqueous hydrogen peroxide solution stripped of sulphates that it contained initially, by passing it over an anionic resin, is again contaminated by sulphates after it passes through a cationic resin (placed downstream of the said anionic resin).

The object of the present invention is to propose a solution to this problem.

For this purpose, the present invention relates to a method of purifying an aqueous hydrogen peroxide solution which comprises passing the solution over at least one cationic resin, in which method, for the purpose of limiting the contamination of the solution by sulphate ions, it is passed over the cationic resin under conditions in which the solution is maintained at a temperature of between its freezing point and +10° C. (limits inclusive).

This low-temperature treatment limits, or even prevents, any contamination of the aqueous hydrogen peroxide solution by sulphate ions.

Advantageously, the treated solution is passed over the cationic resin at a temperature of between 0 and +5° C. (limits inclusive).

The effectiveness of the purification, with respect to the cations contained in the aqueous hydrogen peroxide solution, carried out over the cationic resin at low temperature is not affected. It is very similar to that obtained during purification operations carried out at room temperature (temperature greater than 10° C., or even approximately 20-25° C.).

It is possible to maintain the temperature of the solution passed over the cationic resin at low temperature in various ways. Firstly, it is possible to cool the bed of cationic resin by a pretreatment, by making cooled ultrapure water pass through it. It is also possible to cool the hydrogen peroxide solution to be treated, upstream of its passage over the cationic resin. The method according to the invention can employ one or both of these cooling steps. A person skilled in the art will readily understand that it is necessary for a certain amount of cooled ultrapure water or of cooled hydrogen peroxide solution to flow before the desired temperature in the cationic resin bed is reached. Once the resin bed has been stabilized to the desired temperature, the purification may be carried out without contamination by sulphates.

The cationic resins used according to the invention are generally cationic resins obtained by the sulphonation of a styrene/divinylbenzene copolymer, especially resins obtained by styrene polymerization and crosslinking by divinylbenzene, followed by a treatment in sulphuric acid. Such resins are advantageously used in the cooled state within the context of carrying out the method of the invention.

According to the invention, the aqueous hydrogen peroxide solution to be treated generally contains from 10 to 60% by weight of hydrogen peroxide, preferably 29 to 31% by weight of hydrogen peroxide and even more preferably 30% by weight.

The method of the invention may be limited to cationic purification, that is to say it can be used independently of any treatment of the solution in question over one or more anionic resins, especially during the treatment of hydrogen peroxide solutions having a low concentration of anions.

However, it is generally used within a cationic and an anionic purification context. The said method of the invention therefore generally comprises, apart from passing the solution over at least one cationic resin, passing it over at least one anionic resin. In this case, it is customary to use anionic resins obtained by the amination of a chloromethylstyrene/divinylbenzene copolymer, and the ionic form of which is the carbonate form or the bicarbonate form. Moreover, with reference to the problem of the said anionic resins providing cations, and especially sodium cations, it will be understood that the treated solution is advantageously passed successively over the anionic resin(s) and then over the cationic resin(s). Preferably, with reference to the problem of hydrogen peroxide stability, the anionic resins are also “cooled”. The solution treated according to the invention over an anionic resin is therefore advantageously also passed under conditions in which the solution is maintained at a temperature greater than its freezing point and less than 8° C., advantageously of between 0° C. and +5° C.

In such a context, of successively using one or more anionic resins and one or more cationic resins, the cooling step is preferably carried out on the solution to be treated upstream of the point where it passes over the said resins. Advantageously, it passes over each of the resins (through beds of said resins) in an upward direction.

Preferably, according to the method of the invention, the contact time during which the aqueous hydrogen peroxide solution is in contact with the cationic resin is at most five minutes, the contact time corresponding to the ratio of the volume of cationic resin to the flow rate of the aqueous hydrogen peroxide solution.

The method according to the invention makes it possible to obtain hydrogen peroxide solutions having a sulphate ion concentration of less than 10 ppb.

The invention above is now illustrated by examples.

### EXAMPLES

### Example 1

In laboratory tests, a column containing 100 ml of a cationic resin sold under the brand name DOWEX C650 NG® by Dow, and obtained by the sulphonation of a styrene copolymer crosslinked by divinylbenzene, is fed with an aqueous solution containing 30% by weight hydrogen peroxide at a flow rate of 2 l/h (the contact time is therefore three minutes). The sulphate concentration of the hydrogen peroxide solution to be treated is 10 ppb.

The sulphate concentration of the solution is measured at the outlet of the column.

This test is carried out at various temperatures; for each test, the temperature of the resin and the temperature of the solution to be treated are identical.

For a resin and solution temperature of between +10° and +20° C., it is found that the sulphate concentration at the outlet of the column remains close to 90 ppb, whereas for a temperature of +35° C., the sulphate concentration reaches 400 ppb.

### Example 2

The purification apparatus used essentially comprises two columns placed in series in the following order:

a first column containing eight litres of anionic resin sold under the brand name A550 NG® by Dow; and

a second column containing eight litres of cationic resin sold under the brand name DOWEX C650 NG®.

The apparatus furthermore includes:

means for supplying it with ultrapure water or with the solution to be purified;

means for circulating the water or the solution to be purified; the flow within the first and second columns being in an upward direction;

a heat exchanger placed at the inlet of the first column, so as to cool the water or the solution;

two temperature probes, each placed in a column.

The solution to be purified is a 30% by weight aqueous hydrogen peroxide solution. It is made to flow through the purification apparatus at 120 l/h (the time during which it is in contact with the cationic resin is therefore four minutes).

Before the solution to be treated is introduced into the apparatus, the latter is rinsed in ultrapure water. Next, the hydrogen peroxide solution is sent into the apparatus. The method entails waiting until the temperature within the second column has stabilized before the purified solution is sent to a storage tank.

In a first step, the purification is carried out on the solution maintained at +15° C. and, in a second step, on the solution maintained at +3° C.

Indicated in the table below are the respective nitrate, chloride and phosphate concentrations of the solution, before and after purification.

| | H₂O₂ | Concentration | | Concentration | |
|---|---|---|---|---|---|
| | temperature | in the | | in the | |
| | in the | product before | | product after | |
| | columns | purification | | purification | |
| Sulphates | 15° C. | <10 | ppb | 30 | ppb |
| Nitrates | 15° C. | 410 | ppb | <10 | ppb |
| Chlorides | 15° C. | <10 | ppb | <10 | ppb |
| Phosphates | 15° C. | 70 | ppb | <10 | ppb |
| Sulphates | 3° C. | <10 | ppb | <10 | ppb |
| Nitrates | 3° C. | 300 | ppb | <10 | ppb |
| Chlorides | 3° C. | <10 | ppb | <10 | ppb |
| Phosphates | 3° C. | 80 | ppb | <10 | ppb |

It may be seen that carrying out the purification method according to the present invention at low temperature makes it possible to obtain hydrogen peroxide solutions of low sulphate contamination.

1. Method of purifying an aqueous hydrogen peroxide solution, which comprises passing the solution over at least one cationic resin, characterized in that, for the purpose of limiting the contamination of the solution by sulphate ions, it is passed over the cationic resin under conditions in which the solution is maintained at a temperature of between its freezing point and +10° C., advantageously of between 0° C. and +5° C.

2. Method according to claim 1, characterized in that the cationic resin is obtained by the sulphonation of a styrene/divinylbenzene copolymer.

3. Method according to either of claims 1 and 2, characterized in that the aqueous hydrogen peroxide solution is cooled upstream of the point where it passes over the cationic resin.

4. Method according to any one of claims 1 to 3, characterized in that the aqueous hydrogen peroxide solution contains 10 to 60% by weight of hydrogen peroxide, preferably 29 to 31% by weight, and even more preferably 30% by weight.

5. Method according to one of claims 1 to 4, characterized in that it comprises passing the aqueous hydrogen peroxide solution over at least one anionic resin.

6. Method according to claim 5, characterized in that the solution is passed over the anionic resin under conditions in which it is maintained at a temperature of between its freezing point and +10° C., advantageously between 0° C. and +5° C.

7. Method according to either of claims 5 and 6, characterized in that the aqueous hydrogen peroxide solution is passed successively over at least one anionic resin and then over at least one cationic resin.

8. Method according to any one of claims 1 to 7, characterized in that the contact time during which the aqueous hydrogen peroxide solution is in contact with the cationic resin is at most five minutes.
